(19) United States
(12) Patent Application Publication
(10) Pub. No.: US 2015/0154247 A1
(43) Pub. Date: Jun. 4, 2015

(54) SYSTEM AND METHOD FOR SURFACE DATA MANAGEMENT AT WORKSITE

(71) Applicant: Caterpillar Inc., Peoria, IL (US)

(72) Inventors: Morris W. Reid, Aspley (AU); Dean G. Povey, Aspley (AU); Michael Siemer, Aspley (AU); Mark Banham, Aspley (AU); John R. Ellwood, Aspley (AU)

(73) Assignee: Caterpillar Inc., Peoria, IL (US)

(21) Appl. No.: 14/094,990

(22) Filed: Dec. 3, 2013

(51) Int. Cl. G06F 17/30; B60W 30/00

(52) U.S. Cl. CPC G06F 17/30386; B60W 30/00

(57) ABSTRACT

A system for surface data management for a machine is provided. A first controller maintains an updated surface data and an updating time. A second controller maintains a surface data and a recording time. The second controller transmits a time request for the updating time associated with a destination location. The second controller receives the updating time associated with the destination location. The second controller is compares the updating time with the recording time, each associated with the destination location. If the updating time is more recent than the recording time, the second controller transmits a data request for the updated surface data associated with the destination location and receives the updated surface data. The second controller compares the updated surface data with the surface data, each associated with the destination location and determines a change in the surface data associated with the destination location based on the comparison.

### TECHNICAL FIELD

The present disclosure relates to surface data management, and more specifically to a system and method for the management of a surface data on a worksite having a number of machines operating thereon.

### BACKGROUND

Autonomous machines are being used in a variety of excavation applications, such as, mining applications. For effective and optimal operation of the machine on a worksite, having knowledge of a terrain on which the machine operates may be useful. The terrain of the worksite may undergo changes based on different activities performed thereon by the machines. More specifically, surface data or geospatial information associated with the worksite may change as a result of these activities. For example, on digging of trenches on the worksite due to excavation activities, the surface data associated worksite may be altered. The changes in the terrain may cause difficulty in operating the machine, when the surface data associated with the worksite is inaccurate and/or unknown.

A variety of methods for the collection of the surface data are known. For example, light vehicles may be used to scan the terrain and collect the surface data at worksites. However, the activities being performed by the machines on the worksite may need to be halted on a temporary basis for collecting the surface data. This may lead to an overall decrease in productivity and loss of efficiency. Further, this may also be a tedious task requiring manual supervision for conducting the scan. Apart from using the surface tools, each of the machines may collect the surface data as a background task while operating on the worksite. This surface data may be sent and maintained at an off-site location. However, there may be difficulty in efficiently distributing the surface data to other machines at the worksite.

### SUMMARY OF THE DISCLOSURE

In one aspect of the present disclosure, a system for surface data management for a machine operating on a worksite is provided. The system includes a first controller and a second controller. The first controller is located off-board the machine. The first controller is configured to maintain an updated surface data associated with the worksite and an updating time associated with the updated surface data. The second controller is located on-board the machine. The second controller is communicably coupled to the first controller. The second controller is configured to maintain a surface data associated with the worksite and a recording time associated with the surface data. The second controller is configured to transmit a time request for the updating time associated with a destination location on the worksite. The second controller is configured to receive the updating time associated with the destination location. The second controller is configured to compare the updating time with the recording time, each associated with the destination location. The second controller is configured to transmit a data request for the updated surface data associated with the destination location, if the updating time is more recent than the recording time. The second controller is configured to receive the updated surface data associated with the destination location. The second controller is configured to compare the updated surface data with the surface data, each associated with the destination location. The second controller is configured to determine a change in the surface data associated with the destination location based on the comparison of the updated surface data with the surface data.

In another aspect a method for surface data management for a machine operating on a worksite is provided. The method is implemented by a microprocessor. The method includes maintaining a surface data associated with the worksite and a recording time associated with the surface data. The method includes transmitting a time request for an updating time associated with a destination location on the worksite. The method includes receiving the updating time associated with the destination location. The method includes comparing the updating time with the recording time, each associated with the destination location. The method includes transmitting a data request for an updated surface data associated with the destination location, if the updating time is more recent than the recording time. The method includes receiving the updated surface data associated with the destination location. The method includes comparing the updated surface data with the surface data, each associated with the destination location. The method includes determining a change in the surface data associated with the destination location based on the comparison of the updated surface data with the surface data.

In yet another aspect, a machine operating on a worksite is provided. A controller is located on-board the machine. The controller is configured to maintain a surface data associated with the worksite and a recording time associated with the surface data. The controller is configured to transmit a time request for an updating time associated with a destination location on the worksite. The controller is configured to receive the updating time associated with the destination location. The controller is configured to compare the updating time with the recording time, each associated with the destination location. The controller is configured to transmit a data request for an updated surface data associated with the destination location, if the updating time is more recent than the recording time. The controller is configured to receive the updated surface data associated with the destination location on the worksite. The controller is configured to compare the updated surface data with the surface data, each associated with the destination location. The controller is configured to determine a change in the surface data associated with the destination location based on the comparison of the updated surface data with the surface data. The controller is configured to adjust one or more parameters of the machine based on the determination.

Other features and aspects of this disclosure will be apparent from the following description and the accompanying drawings.

### BRIEF DESCRIPTION OF THE DRAWINGS

FIG. 1 is an exemplary environment in which a surface data management system is employed, according to one embodiment of the present disclosure;

FIG. 2 is a schematic diagram of the surface data management system; and

FIG. 3 is a flowchart of a method for surface data management on a worksite.

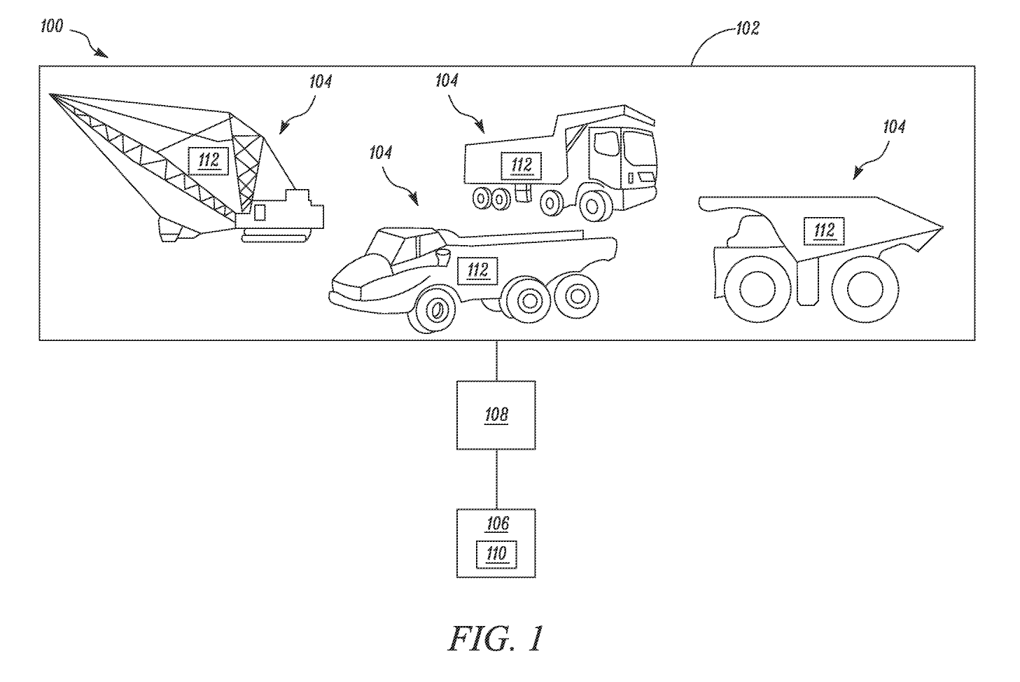

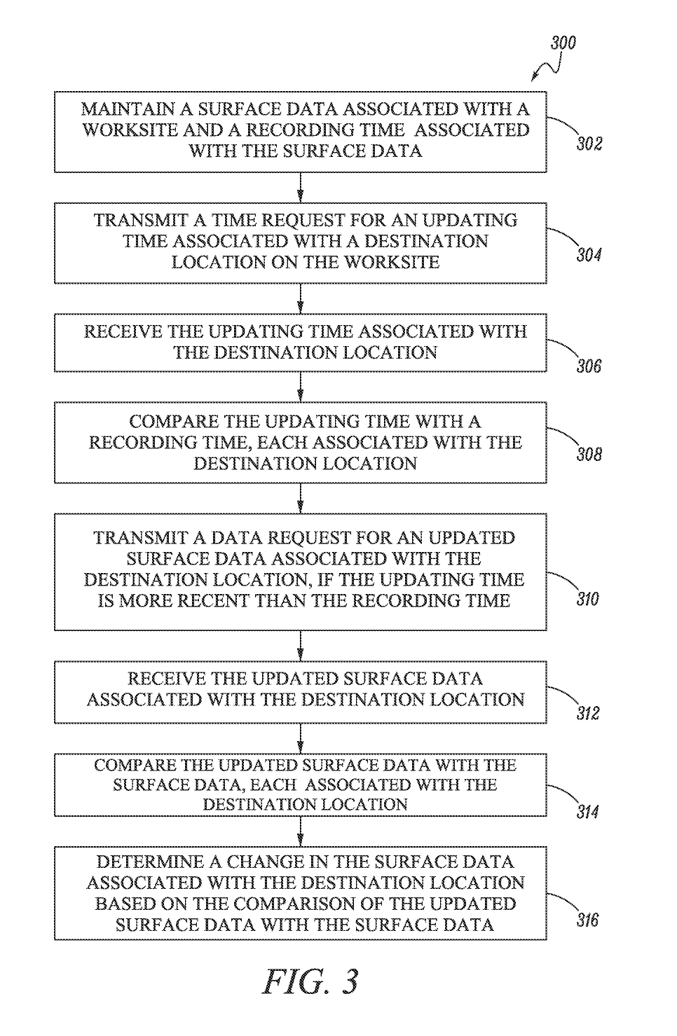

### DETAILED DESCRIPTION

Wherever possible, the same reference numbers will be used throughout the drawings to refer to the same or the like parts. FIG. 1 is an exemplary environment 100 in which a surface data management system may be deployed. In FIG. 1, the environment 100 is embodied as an exemplary worksite 102. A number of different machines 104 configured to transport material from one location to another may be deployed on the worksite 102. The machine 104 may include, but not limited to, a mining truck, a haul truck, an on-highway truck, an off-highway truck, an articulated truck and the like. Further, the machine 104 may also include a number of different loading machines configured to load the material onto the other machines. The type of loading machines may include, but not limited to, a conveyor, a large wheel loader, a track-type loader, a shovel, a dragline, a crane and the like.

The machine 104 may be communicably coupled to a remote control station 106 via a communication system 108. Generally, the remote control station 106 may be located off-worksite. The remote control station 106 may enable remote monitoring and/or controlling of various functions related to the operation of the machine 104.

The communication system 108 may be a wide area network (WAN), a local area network (LAN), an Ethernet, an Internet, an Intranet, a cellular network, a satellite network, or any other suitable network for transmitting data between the machine 104 and the remote control station 106. In various embodiments, the communication system 108 may include a combination of two or more of the aforementioned networks and/or other types of networks known in the art. The communication system 108 may be implemented as a wired network, a wireless network or a combination thereof. Further, data transmission between the machine 104 and the remote control station 106 may occur over the communication system 108 in an encrypted, any other secure format, or in any of a wide variety of known manners.

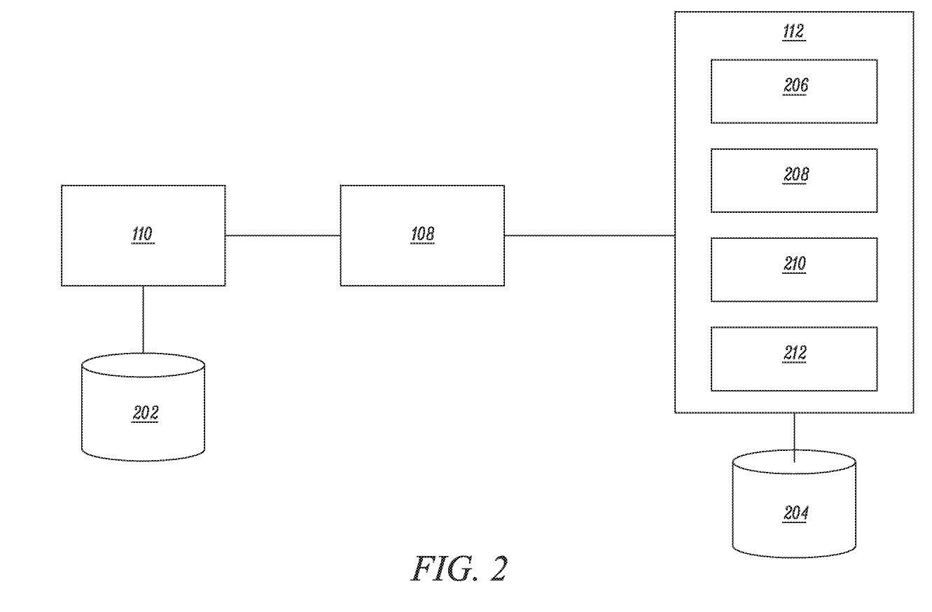

A surface data management system including a first controller 110 and a second controller 112 is disclosed herein. The first controller 110 is located off-board the machine 104. In one embodiment, the first controller 110 may be deployed at the remote control station 106. The second controller 112 may be deployed on-board the machine 104. The first and second controllers 110, 112 may be communicably coupled to each other via the communication system 108. Based on communication with the first controller 110, the second controller 112 is configured to determine change in a surface data associated with the worksite 102. A detailed description of the working of the system will be explained in connection with FIG. 2.

FIG. 2 illustrates a block diagram of the surface data management system. The first controller 110 is communicably coupled to a first database 202. The first database 202 is configured to store and maintain an updated surface data associated with the worksite 102. The first database 202 may include an Oracle® database or any other conventional database known in the art. The term “surface data” used herein refers to terrain information and other parameters associated with the worksite 102. For example, the surface data may include, but not limited to, an elevation, object detection, a radio network signal strength and other geospatial aspects of the worksite 102. In one embodiment, based on the surface data, a surface model of the worksite 102 may be generated using any known technique in the art.

A person of ordinary skill in the art will appreciate that the surface data associated with the worksite 102 may undergo change based on various activities being conducted by the machines 104, such as, for example digging of trenches, hauling of the material, and so on. As described earlier, the first controller 110 is configured to store the updated surface data, wherein the updated surface data includes a latest or updated version of the surface data associated with the worksite 102. In one embodiment, the first controller 110 may collect the updated surface data from the different machines 104 operating on the worksite 102 via the communication system 108. In another embodiment, the updated surface data may be manually stored within the first controller 110. In yet another embodiment, light weight vehicles present on the worksite 102 may send the updated surface data to the first controller 110. Any other known method may be utilized for maintaining the updated surface data at the remote control station 106.

Further, the first controller 110 is configured to maintain an updating time associated with the updated surface data. The term “updating time” used herein, refers to a time at which the surface data maintained by the first controller 110 is updated so as to reflect the most recent changes or modifications in the surface data associated with the worksite 102. One of ordinary skill in the art will appreciate that the worksite 102 may be divided into regions or areas, such that the updated surface data and updating time associated with each of these regions may be maintained by the first controller 110. Further, in one embodiment, different levels of granularity or resolution of the updated surface data may be maintained by the first controller 110. The level of granularity may be defined based on a degree of specificity associated with the surface data of the worksite 102, which is required based upon the application. This level of granularity may be pre-determined or may be provided by an operator. The updated surface data and/or the updating time may be stored in the first database 202.

As shown in FIG. 2, the second controller 112 is communicably coupled to the first controller 110. The second controller 112 is configured to maintain the surface data associated with the worksite 102. For example, during performance of certain activities on the worksite 102, the surface data may be recorded and stored on-board the machine 104 by one or more sensors present on the machine 104. Alternatively, the surface data may be gathered or collected from other sources external to the machine 100. The surface data may be collected by the second controller 112 from different sources and processed to either merge or replace the existing surface data.

Also, the second controller 112 is configured to maintain a recording time associated with the surface data. The term “recording time” used herein, refers to a time at which the surface data is determined. More specifically, the recording time is associated with the time at which the surface data is stored on-board the machine 104. As described earlier, the surface data and the respective recording times corresponding to distinct regions of the worksite 102 may be maintained by the second controller 112. In one embodiment, the surface data and/or the recording time may be stored in a second database 204. The second database 204 may include an Oracle® database or any other conventional database known in the art. Further, the second database 204 may be intrinsic or extrinsic to the second controller 112, based on the application.

The second controller 112 may include a transmission module 206 configured to transmit a time request for the updating time associated with a destination location on the worksite 102. The destination location may include any specific area or region on the worksite 102 to which the machine 104 may need to be moved. This destination location may be selected in a variety of ways. For example, in one embodiment, the destination location may be selected based on a pre-defined or scheduled task being performed by the machine 104. In another embodiment, the destination location may be externally provided by the operator at the remote control station 106, and then communicated to the second controller 112 via the communication system 108.

The destination location may include a position information associated with the destination location. The position information may include at least one co-ordinate lying within the destination location and/or an area, a region or a zone associated with the destination location. For example, the request includes the co-ordinate of a center point and a defined area around the center point. Further, in one embodiment, the destination location may additionally include a resolution information associated with the destination location. The resolution information is based on a degree of specificity required by the machine 104. For example, based on the task to be performed by the machine 104, if more specificity is required in relation to a certain territorial aspect of the destination location, then accordingly the desired resolution may be included in the request. It should be noted that the degree of specificity provided in the request may be of a resolution lesser or equal to that of the updated surface data stored in the first database 202. Also, in one embodiment, the destination location may be divided into a number of areas, such that each request sent by the second controller 112 may be specific to distinct areas of the destination location. Accordingly, the second controller 112 may transmit multiple requests each associated with the respective area of the destination location. This may allow for reduction in calculation or computation at the first and second controllers 110, 112 end and/or a reduction in bandwidth for communication between the first and second controllers 110, 112.

This time request may be transmitted to the first controller 110 via the communication system 108. The first controller 110 may retrieve the updating time of the destination location from the first database 202. The updating time associated with the destination location may be transmitted to the second controller 112 via the communication system 108. Further, a receiver module 208 of the second controller 112 may receive the updating time associated with the destination location.

The second controller 112 may also include a comparison module 210. The comparison module 210 is configured to retrieve the recording time associated with the destination location from the second database 204. The comparison module 210 may then compare the recording time with the received updating time associated with the destination location. In some embodiments, the recording time and the respective updating time for different points or positions within the destination location may be compared based on the degree of specificity required by the machine 104, according to the resolution information transmitted in the request.

In one situation, the recording time may be more recent than the updating time. This situation may arise when the surface data associated with the destination location is more recent than that present at the remote control station 106. Accordingly, the second controller 112 may be configured to transmit the surface data and the recording time associated with the destination location to the first controller 110 for updating the first database 202.

In another situation, when the updating time is more recent then the recording time for the given destination location, the transmission module 206 of the second controller 112 may transmit a data request for the updated surface data associated with the destination location via the communication system 108. The first controller 110 may retrieve the updated surface data of the destination location from the first database 202. The updated surface data associated with the destination location may be transmitted to the second controller 112 via the communication system 108. Further, the receiver module 208 of the second controller 112 may receive the updated surface data associated with the destination location.

In one embodiment, the transmission module 206 of the second controller is configured to transmit the data request for the updated surface data associated with the destination location from a pre-determined time. This pre-determined time may be based on a time at which a last update of the surface data may have taken place at the second database 204. Accordingly, the data request may be transmitted from the second controller 112 to the first controller 110, requesting for the updated surface data stored within the first database 202 after the pre-determined time.

The receiver module 208 of the second controller 112 may receive the updated surface data associated with the destination location based on the data request. Further, the comparison module 210 of the second controller 112 may retrieve the surface data associated with the destination location from the second database 204. The comparison module 210 is configured to compare the received updated surface data with the surface data associated with the destination location. A surface data module 212 of the second controller 112 is configured to determine the change in the surface data based on the comparison of the updated surface data and the surface data associated with the destination location.

This change in the surface data may be computed or determined in a variety of ways. For example, a difference in the updated surface data and the surface data may be computed for the given destination location using techniques known in the art. In one embodiment, when the change in the surface data associated with the destination location is determined, the surface data and the corresponding recording time stored in the second database 204 may be accordingly updated in order to reflect the change in the surface data associated with the destination location. In yet another situation, the recoding time and the updating time may be identical. In this case, the second controller 112 may be configured to determine that minimalistic or close to zero change in the surface data associated with the destination location has taken place.

When the change in the surface data is determined by the second controller 112 different actions may be taken, according to various embodiments of the present disclosure. Some of these actions will be described herein. For example, in one embodiment, the second controller 112 may be communicably coupled to an electronic control module of the machine 104. The electronic control module or any other known control system on-board the machine 104 is configured to control an operation of the machine 104 at the worksite 102. Accordingly, the second controller 112 may be configured to send control signals to the electronic control module to adjust the operation of the machine 104 on the worksite 102 based on the change in the surface data.

More specifically, the adjusting may include controlling of one or more parameters of the machine 104. The one or more parameters of the machine 104 may include, but not limited to, a speed of the machine 104, and a direction of travel of the machine 104, a power output of the machine 104 and the like. For example, based on the change on the surface data if an obstacle is detected on the worksite 102, the second controller 112 may send the control signal for operating an implement of the machine 104 to push aside the obstacle. In another example, the change in the surface data may be used to calculate grades and/or surface roughness of the worksite 102, which may further be used for the actions like selecting optimal driving parameters associated with the machine 100 or determining drivability of the machine 100 on the worksite 102. In another embodiment, the change in the surface data may be displayed on a display unit. For example, the change in the surface data may be shown on the display unit of the remote control station 106 using any known model. The operator may accordingly perform desired actions based on the display.

Numerous commercially available microprocessors may be configured to perform the functions of the first and/or the second controllers 110, 112. It should be appreciated that the first and/or the second controllers 110, 112 may readily embody a general machine microprocessor capable of controlling numerous machine functions. A person of ordinary skill in the art will appreciate that the first and/or the second controllers 110, 112, may additionally include other components and may also perform other functionality not described herein. It should be understood that the embodiments and the configurations and connections explained herein are merely on an exemplary basis and may not limit the scope and spirit of the disclosure.

### INDUSTRIAL APPLICABILITY

The present disclosure relates to a method 300 for the management of the surface data for the machine 104 operating on the worksite 102. The system disclosed herein provides for efficient distribution of the surface data to the machine 104 from the remote control station 106, based on the request transmitted by the machine 104. Further, due to reduction in a stoppage of the machines 104 on the worksite 102, there may be an increase in utilization and productivity of the machines 104. Also, the above disclosure is explained in connection with autonomous machines 104 on an exemplary basis. The system disclosed herein may also be utilized on semi-autonomous machines or manned machines without deviating from the scope of the present disclosure. The term “autonomous machine” used herein refers to those machines which may be operated and controlled from a remote location. The term “semi-autonomous machine” used herein refers to those machines which may be at least partially operated by the operator seated within the machine. For example, the operator may provide a command for initiating machine activities and further control may be autonomous.

At step 302, the surface data associated with the worksite 102 and the recording time associated with the surface data may be maintained by the second controller 112. At step 304, the transmission module 206 may transmit the time request for the updating time associated with the destination location on the worksite 102.

At step 306, the receiver module 208 may receive the updating time associated with the destination location on the worksite 102. At step 308, the comparison module 210 may compare the updating time and the recording time associated with the destination location. At step 310, if the updating time is more recent than the recording time, the transmission module 206 may transmit the data request for the updated surface data associated with the destination location on the worksite 102.

At step 312 the receiver module 208 may receive the updated surface data associated with the destination location on the worksite 102. At step 314, the comparison module 210 may compare the updated surface data and the surface data associated with the destination location. At step 316, the surface data module 212 may determine the change in the surface data associated with the destination location based on the comparison of the updated surface data and the surface data. Further, in one embodiment, the second controller 112 may adjust the operation of the machine 104 based on the change in the surface data. The second controller 112 may also update the surface data stored within the second database 204 based on the change.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for surface data management for a machine operating on a worksite, the system comprising:
a first controller located off-board the machine, the first controller configured to maintain an updated surface data associated with the worksite and an updating time associated with the updated surface data; and
a second controller located on-board the machine, the second controller communicably coupled to the first controller, the second controller configured to:
maintain a surface data associated with the worksite and a recording time associated with the surface data;
transmit a time request for the updating time associated with a destination location on the worksite;
receive the updating time associated with the destination location;
compare the updating time with the recording time, each associated with the destination location;
transmit a data request for the updated surface data associated with the destination location, if the updating time is more recent than the recording time;
receive the updated surface data associated with the destination location;
compare the updated surface data with the surface data, each associated with the destination location; and
determine a change in the surface data associated with the destination location based on the comparison of the updated surface data with the surface data.

2. The system of claim 1, wherein the second controller is further configured to:
adjust one or more parameters of the machine based on the determination.

3. The system of claim 2, wherein the one or more parameters include at least one of a speed of the machine, a direction of travel of the machine, and a power output of the machine.

4. The system of claim 1, wherein the second controller is configured to:
transmit the data request for the updated surface data associated with the destination location from a pre-determined time;
receive the updated surface data associated with the destination location;
compare the updated surface data with the surface data, each associated with the destination location; and
determine the change in the surface data associated with the destination location based on the comparison of the updated surface data with the surface data.

5. The system of claim 1, wherein the second controller is further configured to:
update the surface data and the recording time associated with the destination location on the worksite based on the determination.

6. The system of claim 1, wherein the destination location includes a position information associated with the destination location on the worksite, the position information including at least one of a co-ordinate associated with the destination location and an area on the worksite.

7. The system of claim 6, wherein the destination location includes a resolution information based on a degree of specificity required for the destination location.

8. The system of claim 1, wherein the second controller is further configured to:
determine the destination location on the worksite based on a scheduled task to be performed by the machine.

9. The system of claim 1, wherein the first controller is located at a remote control station.

10. The system of claim 1, wherein the machine is an autonomous machine.

11. A method for surface data management for a machine operating on a worksite, the method being performed by a microprocessor, the method comprising:
maintaining a surface data associated with the worksite and a recording time associated with the surface data;
transmitting a time request for an updating time associated with a destination location on the worksite;
receiving the updating time associated with the destination location;
comparing the updating time with the recording time, each associated with the destination location;
transmitting a data request for an updated surface data associated with the destination location, if the updating time is more recent than the recording time;
receiving the updated surface data associated with the destination location;
comparing the updated surface data with the surface data, each associated with the destination location; and
determining a change in the surface data associated with the destination location based on the comparison of the updated surface data with the surface data.

12. The method of claim 11 further comprising:
adjusting one or more parameters of the machine based on the determination.

13. The method of claim 12, wherein the one or more parameters include at least one of a speed of the machine, a direction of travel of the machine, and a power output of the machine.

14. The method of claim 11 further comprising:
transmitting the data request for the updated surface data associated with the destination location from a pre-determined time;
receiving the updated surface data associated with the destination location;
comparing the updated surface data with the surface data, each associated with the destination location; and
determining the change in the surface data associated with the destination location based on the comparison of the updated surface data with the surface data.

15. The method of claim 11 further comprising:
updating the surface data and the recording time associated with the destination location on the worksite based on the determination.

16. The method of claim 11 further comprising:
determining the destination location on the worksite based on a scheduled task to be performed by the machine.

17. A machine operating on a worksite, the machine comprising:
a controller located on-board the machine, the controller configured to:
maintain a surface data associated with the worksite and a recording time associated with the surface data;
transmit a time request for an updating time associated with a destination location on the worksite;
receive the updating time associated with the destination location;
compare the updating time with the recording time, each associated with the destination location;
transmit a data request for an updated surface data associated with the destination location, if the updating time is more recent than the recording time;
receive the updated surface data associated with the destination location on the worksite;
compare the updated surface data with the surface data, each associated with the destination location;
determine a change in the surface data associated with the destination location based on the comparison of the updated surface data with the surface data; and
adjust one or more parameters of the machine based on the determination.

18. The machine of claim 17, wherein the one or more parameters include at least one of a speed of the machine, a direction of travel of the machine, and a power output of the machine.

19. The machine of claim 17, wherein the destination location includes a position information associated with the destination location on the worksite, the position information including at least one of a co-ordinate associated with the destination location and an area on the worksite.

20. The machine of claim 19, wherein the destination location includes a resolution information based on a degree of specificity required for the destination location.
